(19) United States
(12) Patent Application Publication
(10) Pub. No.: US 2012/0268545 A1
(43) Pub. Date: Oct. 25, 2012

(54) RIBBON CAPABLE OF ENHANCING CUTTING PRECISION

(76) Inventors: Chien-Ju Chen, Keelung City (TW); Yao-Hsien Huang, New Taipei City (TW)

(21) Appl. No.: 13/117,148

(22) Filed: May 27, 2011

(30) Foreign Application Priority Data
Apr. 21, 2011 (TW) 100113900

(51) Int. Cl. B41J 2/325

(52) U.S. Cl. 347/213

(57) ABSTRACT

A ribbon includes at least one dye region, at least one separating region and at least one recognition dye region. Each of the dye regions includes a plurality of dye zones. The separating region is formed on a side of the dye region for separating different dye regions. The recognition dye region is formed on the separating region or formed within a range covered by the corresponding dye region. A thermal print head of a thermal sublimation printer transfers the dye region and the recognition dye region of the ribbon onto a print medium, so as to form an image area and a recognition mark on the print medium, correspondingly. A cutting mechanism of the thermal sublimation printer is used for cutting the print medium when a sensor of the thermal sublimation printer senses the recognition mark.

### BACKGROUND OF THE INVENTION

1. Field of the Invention

The present invention relates to a ribbon, and more particularly, to a ribbon adapted to a thermal sublimation printer for enhancing cutting precision.

2. Description of the Prior Art

A conventional thermal sublimation printer with duplex printing function utilizes a motor to drive a feeding mechanism with a rubber roller, so as to move a print medium to a position where a thermal print head is located. Afterwards, the thermal print head transfers dyes on a ribbon onto the print medium. After completing dye transferring, the motor continues to drive the feeding mechanism for moving the print medium to a position where a cutting mechanism is located. The cutting mechanism is used for cutting the print medium, so as to make a length of the print medium with a printed image be identical to that of a physical image. Consequently, and it is easy and convenient for a user to take the said cutting printed medium.

A conventional method for calculating the length for cutting the print medium is to convert movement steps of a stepping motor into the length which the print medium has been moved according to a gear ratio of a transmission system together with a radius of the rubber roller. Consequently, the thermal sublimation printer can control the cutting mechanism to cut the print medium according to the length which the print medium has been moved, so as to make the print medium meet the length of the physical image. However, both of a slip between the rubber roller and the print medium and an abnormal functioning of the stepping motor will result in error of calculating the length which the print medium has been moved. As a result, the length of the print medium with the printed image does not meet that of the physical image.

Furthermore, a conventional solution to solve issue of the slip between the rubber roller and the print medium is to use a metal roller with spurs driven by the stepping motor for holding the print medium. With the print medium being pierced by the spurs on the roller, it results in that motion between the print medium and the roller is a pure rolling without slipping. However, such kind of design will fracture the surface of the print medium so as to affect quality of printing, and even worse for duplex printing. Accordingly, design for a printing mechanism capable of cutting the print medium precisely and with good quality of printing becomes an important issue in the printer industry.

### SUMMARY OF THE INVENTION

The present invention provides a ribbon adapted to a thermal sublimation printer for enhancing cutting precision.

According to the claimed invention, the present invention provides a ribbon adapted to a thermal sublimation printer. The thermal sublimation printer includes a thermal print head, a sensor and a cutting mechanism. The ribbon includes at least one dye region including a plurality of dye zones, at least one separating region formed on a side of the at least one dye region for separating different dye regions, and at least one recognition dye region formed on the at least one separating region or formed within a range covered by the corresponding at least one dye region. The thermal print head of the thermal sublimation printer transfers the at least one dye region and the at least one recognition dye region of the ribbon onto a print medium, so as to form an image area and a recognition mark on the print medium correspondingly, and the cutting mechanism of the thermal sublimation printer cuts the print medium when the sensor of the thermal sublimation printer senses the recognition mark.

According to the claimed invention, the at least one recognition dye region is made of a dark-colored dye capable of absorbing an infrared ray.

According to the claimed invention, the dark-colored dye is made of K-Resin material.

According to the claimed invention, the at least one recognition dye region is formed between two dye zones of the plurality of dye zones.

According to the claimed invention, the plurality of dye zones includes a yellow dye zone, a magenda dye zone, a cyan dye zone and an overcoating zone.

According to the claimed invention, the at least one dye region comprises at least one ribbon recognition zone formed among the plurality of dye zones.

In summary, the dye region and the recognition dye region of the ribbon of the present invention can be transferred onto the print medium by the thermal print head of the thermal sublimation printer, so as to form the image region and the recognition mark on the print medium, correspondingly. Afterwards, the cutting mechanism of the thermal sublimation printer can cut the print medium when the thermal sublimation printer senses the recognition mark. In such a manner, based on the aforesaid mechanism, a length of the print medium cut by the cutting mechanism of the present invention can be identical to a length of the image region on the print medium exactly. In other words, the present invention utilizes whether the sensor senses the recognition mark on the print medium for controlling the cutting mechanism to cut the print medium instead of converting movement steps of a stepping motor into the length which the print medium has been moved according to a gear ratio of a transmission system together with a radius of the rubber roller in the prior art. Consequently, the present invention can avoid issues of a slip between the rubber roller and the print medium and an abnormal functioning of the stepping motor. As a result, the present invention can utilize rubber rollers for holding and conveying the print medium for avoiding from fracturing the surface of the print medium. In such a manner, the ribbon of the present invention can enhance cutting precision of the thermal sublimation printer and keep print quality as well.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating a ribbon adapted to a thermal sublimation printer according to a preferred embodiment of the present invention.

FIG. 2 is a schematic diagram of a cutting mechanism according to the preferred embodiment of the present invention.

FIG. 3 is a partially schematic diagram of the ribbon according to the preferred embodiment of the present invention.

FIG. 4 is a partially schematic diagram of a print medium on a printing side.

FIG. 5 is a partially schematic diagram of a ribbon according to another embodiment of the present invention.

FIG. 6 is a partially schematic diagram of a ribbon according to another embodiment of the present invention.

### DETAILED DESCRIPTION

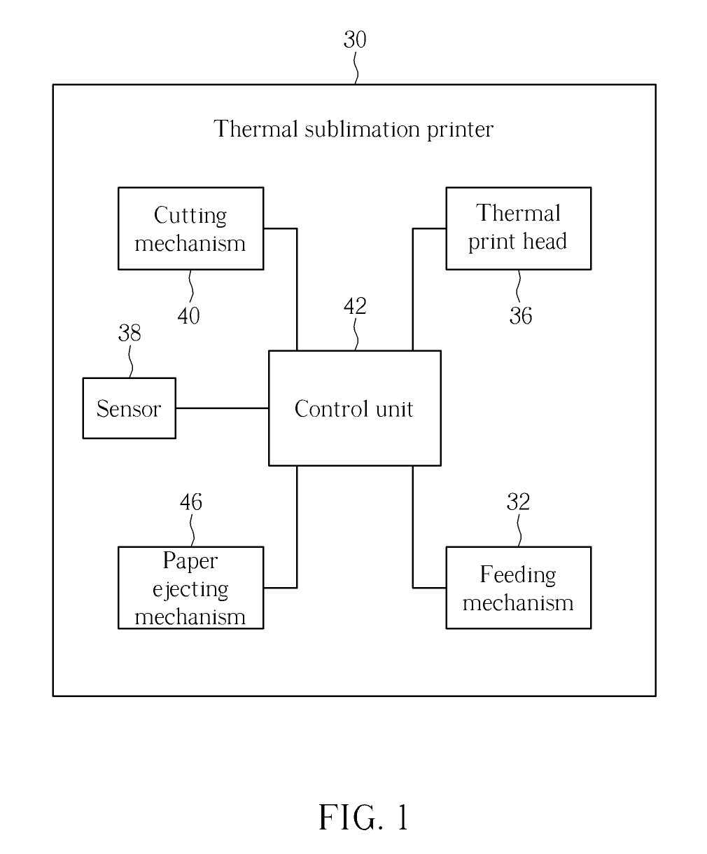

Please refer to FIG. 1. FIG. 1 is a functional block diagram illustrating a ribbon 34 adapted to a thermal sublimation printer 30 according to a preferred embodiment of the present invention. As shown in FIG. 1, the thermal sublimation printer 30 includes a feeding mechanism 32, a thermal print head 36, a sensor 38, a cutting mechanism 40 and a control unit 42. The feeding mechanism 32 is used for moving a print medium 44 such as a sheet of paper, and the thermal print head 36 is used for transferring dyes on the ribbon 34 onto the print medium 44. In this embodiment, the feeding mechanism 32 can be preferably a rubber roller transmission system for avoiding from fracturing the surface of print medium 44, so as to keep print quality.

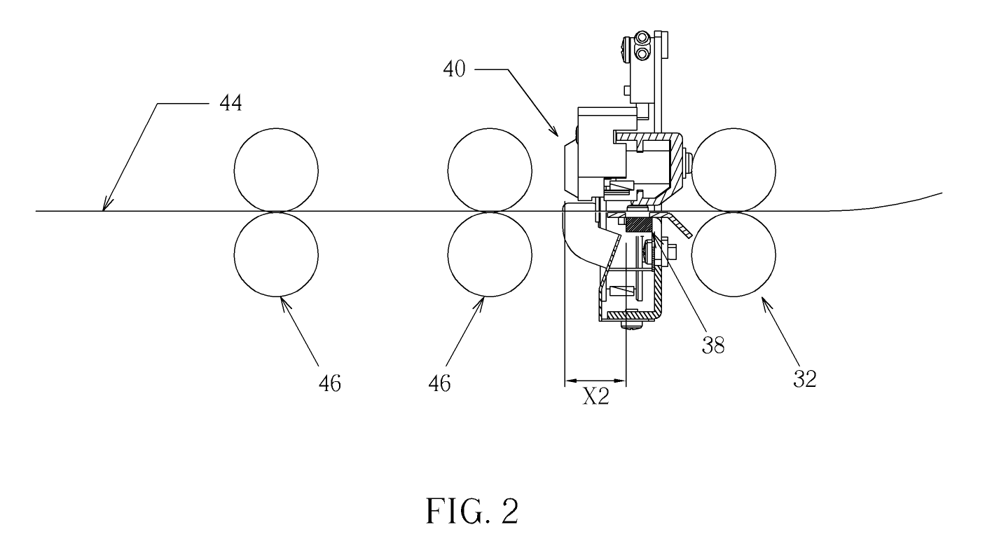

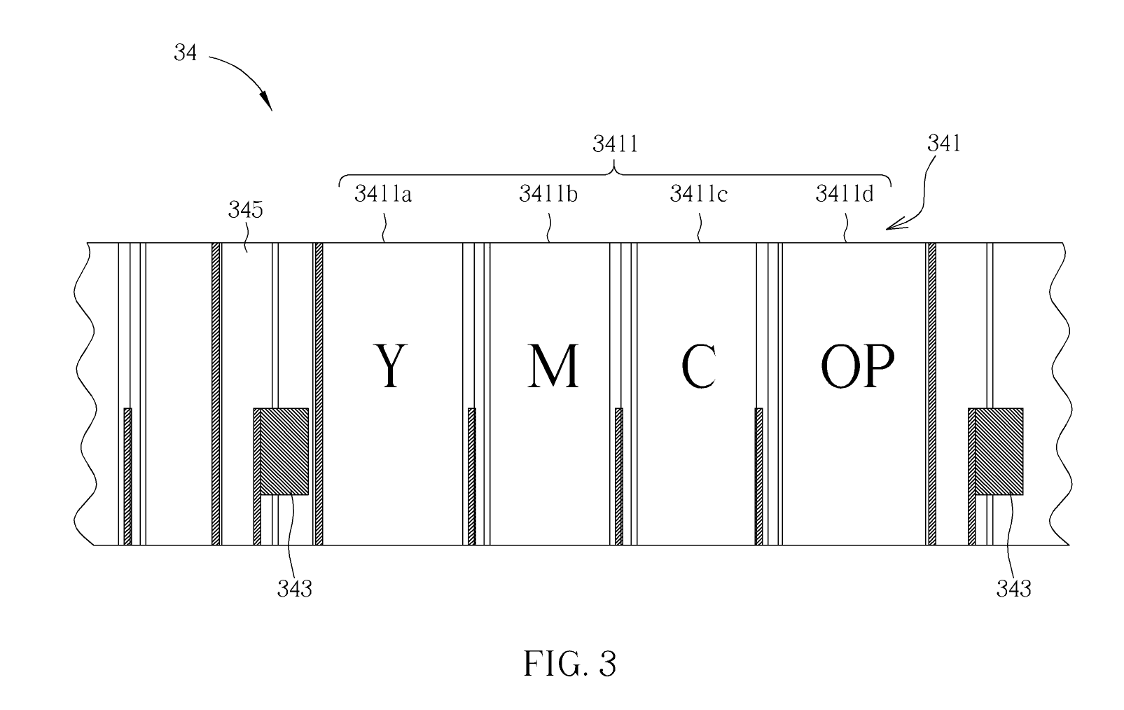

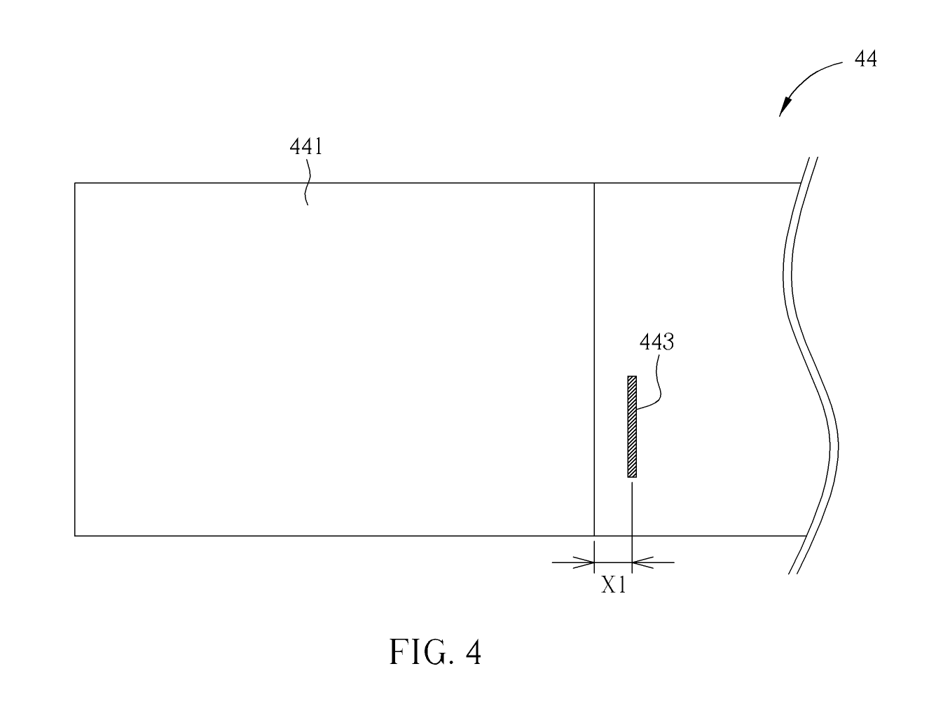

Please refer to FIG. 1 to FIG. 4. FIG. 2 is a schematic diagram of the cutting mechanism 40 according to the preferred embodiment of the present invention. FIG. 3 is a partially schematic diagram of the ribbon 34 according to the preferred embodiment of the present invention. FIG. 4 is a partially schematic diagram of the print medium 44 on a printing side. As shown in FIG. 1 to FIG. 4, the thermal print head 36 is used for transferring at least one dye region 341 onto the print medium 44, so as to form an image region 441 on the print medium 44, correspondingly. In addition, each of the dye regions 341 can include a plurality of dye zones 3411, as four dye zones 3411 shown in FIG. 4. In practical application, the plurality of dye zones 3411 can include a yellow dye zone 3411a, a magenda dye zone 3411b, a cyan dye zone 3411c and an overcoating zone 3411d. The image region 441 can be formed in a thermal transferring manner by individually or collectively using the aforesaid plurality of dye zones 3411, as well as the corresponding protective layer on the image region 441 for protecting dyes transferred on the image region 441.

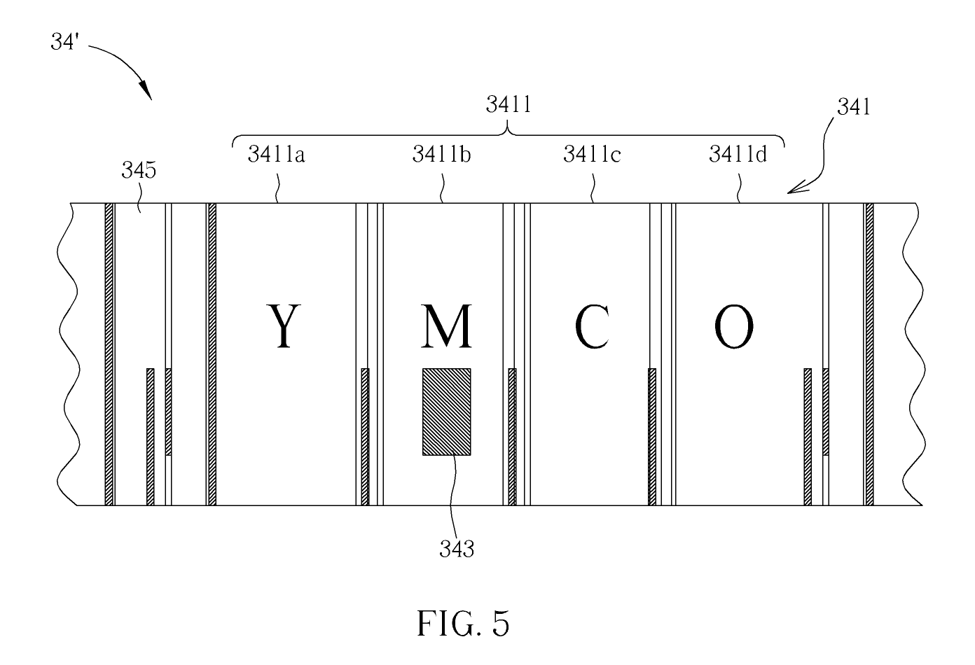

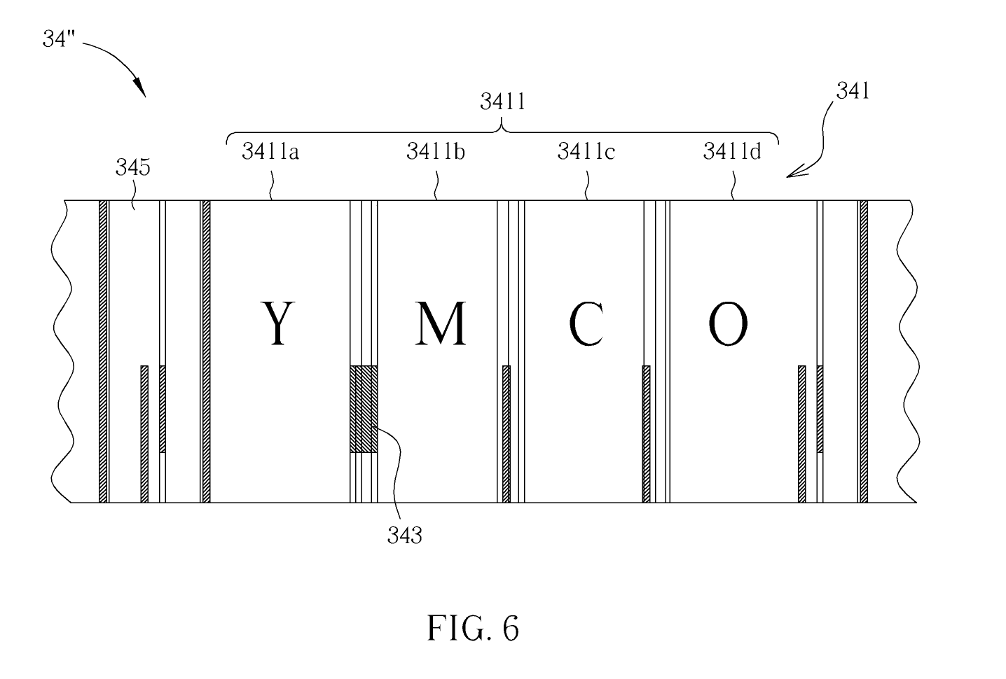

Furthermore, the ribbon 34 further includes at least one recognition region 343 and at least one separating region 345. The separating region 345 is formed on a side of the dye region 341 for separating different dye regions 341. Please refer to FIG. 3 again. As shown in FIG. 3, the recognition region 343 is formed on the separating region 345. In other words, in this embodiment, since the separating region 345 is located between the two adjacent dye regions 341, the recognition region 343 is formed between the two adjacent dye regions 341 as well. It should be noticed that disposal of the recognition regions 343 on the ribbon 34 can not be limited to that mentioned in the aforesaid embodiment. For example, please refer to FIG. 5. FIG. 5 is a partially schematic diagram of a ribbon 34′ according to another embodiment of the present invention. As shown in FIG. 3 and FIG. 5, the main difference between the ribbon 34′ and the aforesaid ribbon 34 is that the recognition region 343 as shown in FIG. 5 is formed on one of the plurality of dye zones 3411. For example, the recognition region 343 can be formed on the magenda dye zone 3411b as shown in FIG. 5. On the other hand, please refer to FIG. 6. FIG. 6 is a partially schematic diagram of a ribbon 34″ according to another embodiment of the present invention. As shown in FIG. 3 and FIG. 6, the main difference between the ribbon 34″ and the aforesaid ribbon 34 is that the recognition region 343 as shown in FIG. 6 is formed between the two dye zones 3411a, 3411b, 3411c, 3411d. In other words, the recognition region 343 can be formed on the separating region 345 or be formed within a range covered by the corresponding dye region 341. As for which design of the above-mentioned recognition region 343 is adopted, it depends on practical demands.

In practical application, the recognition region 343 can be made of a dark-color dye capable of absorbing an infrared ray. For example, the dark-color dye can be made of K-Resin material. Furthermore, the thermal print head 36 can transfer the recognition region 343 on the ribbon 34 onto the print medium 44, so as to form a recognition mark 443. The image region 441 is away from the recognition mark 443 by a first distance X1. In addition, the sensor 38 of the thermal sublimation printer 30 of the present invention is used for sensing the recognition mark 443 on the print medium 44, and the cutting mechanism 40 is used for cutting the print medium 44. The sensor 38 is away from the cutting mechanism 40 by a second distance X2. In practical application, the sensor 38 can preferably be an infrared sensor, and the first distance X1 can be substantially equal to the second distance X2.

In addition, the thermal sublimation printer 30 can further include a paper ejecting mechanism 46 for driving the print medium 44 to depart from the cutting mechanism 40, so as to avoid paper jam when utilizing the thermal sublimation printer 30 for printing and cutting. In practical application, the paper ejecting mechanism 46 can preferably be a rubber roller transmission mechanism.

As for cutting the print medium 44, the control unit 42 controls the cutting mechanism 40 to cut the print medium 44 when the sensor 38 senses the recognition mark 443 on the print medium 44. At the same time, the cut print medium 44 is driven by the paper ejecting mechanism 46 to depart from the cutting mechanism 40. Since the first distance X1 between the image region 441 and the recognition mark 443 is substantially equal to the second distance X2 between the sensor 38 and the cutting mechanism 40, a cutting position for the cutting mechanism 40 is right at an end of the image region 441 when the sensor 38 senses the recognition region 343 on the print medium 44. In such a manner, a length of the cut print medium 44 is precisely identical to a length of the image region 441 on the print medium 44, so as to enhance cutting precision for cutting the print medium 44.

Compared with the prior art, the dye region and the recognition dye region of the ribbon of the present invention can be transferred onto the print medium by the thermal print head of the thermal sublimation printer, so as to form the image region and the recognition mark on the print medium, correspondingly. Afterwards, the cutting mechanism of the thermal sublimation printer can cut the print medium when the thermal sublimation printer senses the recognition mark. In such a manner, based on the aforesaid mechanism, a length of the print medium cut by the cutting mechanism of the present invention can be identical to a length of the image region on the print medium exactly. In other words, the present invention utilizes whether the sensor senses the recognition mark on the print medium for controlling the cutting mechanism to cut the print medium instead of converting movement steps of a stepping motor into the length which the print medium has been moved according to a gear ratio of a transmission system together with a radius of the rubber roller in the prior art. Consequently, the present invention can avoid issues of a slip between the rubber roller and the print medium and an abnormal functioning of the stepping motor. As a result, the present invention can utilize rubber rollers for holding and conveying the print medium for avoiding from fracturing the surface of the print medium. In such a manner, the ribbon of the present invention can enhance cutting precision of the thermal sublimation printer and keep print quality as well.

Those skilled in the art will readily observe that numerous modifications and alterations of the device and method may be made while retaining the teachings of the invention.

What is claimed is:

1. A ribbon adapted to a thermal sublimation printer, the thermal sublimation printer comprising a thermal print head, a sensor and a cutting mechanism, the ribbon comprising:
at least one dye region comprising a plurality of dye zones;
at least one separating region formed on a side of the at least one dye region for separating different dye regions; and
at least one recognition dye region formed on the at least one separating region or formed within a range covered by the corresponding at least one dye region;
wherein the thermal print head of the thermal sublimation printer transfers the at least one dye region and the at least one recognition dye region of the ribbon onto a print medium, so as to form an image area and a recognition mark on the print medium correspondingly, and the cutting mechanism of the thermal sublimation printer cuts the print medium when the sensor of the thermal sublimation printer senses the recognition mark.

2. The ribbon of claim 1, wherein the at least one recognition dye region is made of a dark-colored dye capable of absorbing an infrared ray.

3. The ribbon of claim 2, wherein the dark-colored dye is made of K-Resin material.

4. The ribbon of claim 1, wherein the at least one recognition dye region is formed between two dye zones of the plurality of dye zones.

5. The ribbon of claim 1, wherein the plurality of dye zones comprises a yellow dye zone, a magenda dye zone, a cyan dye zone and an overcoating zone.

6. The ribbon of claim 1, wherein the at least one dye region comprises at least one ribbon recognition zone formed among the plurality of dye zones.
